(19) United States
(12) Patent Application Publication
(10) Pub. No.: US 2021/0209923 A1
(43) Pub. Date: Jul. 8, 2021

(54) SERVER, SYSTEM AND CONTROL METHOD

(71) Applicant: NEC CORPORATION, Tokyo (JP)

(72) Inventor: Takahiro KUMURA, Tokyo (JP)

(73) Assignee: NEC CORPORATION, Tokyo (JP)

(21) Appl. No.: 16/087,340

(22) PCT Filed: Mar. 13, 2017
(86) PCT No.: PCT/JP2017/009882

§ 371 Date: Sep. 21, 2018

(30) Foreign Application Priority Data
Mar. 23, 2016 (JP) 2016-058797

(51) Int. Cl. G08B 21/18; H04W 4/02; H04W 4/029; H04W 84/18; H04W 24/10

(52) U.S. Cl. CPC G08B 21/18; H04W 4/023; H04W 24/10; H04W 84/18; H04W 4/029

(57) ABSTRACT

Provided is a system which allow a server to acquire information for grasping a state of an object, even when a communication bandwidth is limited. In a detection system, each of a plurality of sensor units transmits, when an event has been detected, event information indicating that the event has occurred, to the server, and the server identifies, when the event information has been reported from at least one of the plurality of sensor units, at least one sensor unit different from the sensor unit from which the event information has been reported, from among the plurality of sensor units, and acquires data related to the event from the identified sensor unit.

### TECHNICAL FIELD

The present invention relates to a sensor unit, a server, a system including a sensor unit and a server, a server control method, and a recording medium.

### BACKGROUND ART

A sensor network is used in order to monitor or control a state of a factory or a social infrastructure. In general, the sensor network includes sensors that collect data and a server that collects data from the sensors. The sensors are installed at respective positions on an object such as a production facility, a bridge, a tunnel, or a water network, and measure physical amounts. The server collects data of the physical amounts from the sensors through a communication network. Further, the server analyzes the collected data, and monitors and controls the object. A communication bandwidth available in the sensor network used to monitor or control the object is very small, compared with a communication bandwidth of an advanced mobile phone network. Therefore, information amount transmittable through thin channels available in the sensor network is limited.

In view of the above issue, a technique of sensors that decrease a sampling rate to acquire physical amounts is generally used (PTL 1).

As a related technique, PTL 2 discloses a distributed measurement system using a plurality of sensors. PTL 3 discloses a pipeline management support system.

### CITATION LIST

### Patent Literature

PTL 1: Japanese Patent Application Laid-Open Publication No. 2014-74611
PTL 2: Japanese Patent Application Laid-Open Publication No. 2008-209995
PTL 3: European Patent Application Laid-Open Publication No. 2838067 Description

### SUMMARY OF INVENTION

### Technical Problem

Decreasing a sampling rate of sensors as in the technique disclosed in PTL 1 means that observable state of an object could decrease. In other words, when an information amount is reduced by decreasing the sampling rate of the sensors, it is difficult to grasp a state of the object in detail. Therefore, the server may not acquire sufficient information amount to an extent that a state of the object can be grasped in detail.

One of exemplary aims of the present invention is to provide a sensor unit, a server, a system including a sensor unit and a server, a server control method, and a recording medium, all of which allow the server to acquire information for grasping a state of an object, even when a communication bandwidth is limited.

### Solution to Problem

A system according to an exemplary aspect of the present invention includes: a plurality of sensor units; and a server communicable with each of the plurality of sensor units, wherein each of the plurality of sensor unit includes: communication means for transmitting, when an event has been detected, event information indicating that the event has occurred, to the server, and the server includes: identification means for identifying, when the event information has been reported from at least one of the plurality of sensor units, at least one sensor unit different from the sensor unit from which the event information has been reported, from among the plurality of sensor units; and server communication means for acquiring data related to the event from the sensor unit identified by the identification means.

A sensor unit according to an exemplary aspect of the present invention includes: detection means for measuring data related to a physical amount; control means for detecting an event, based on the data; and communication means for reporting, when the event has been detected, event information indicating that the event has been occurred, to a server, wherein the control means causes, when receiving a data transmission request from the server, the communication means to transmit the data related to the event to the server.

A server according to an exemplary aspect of the present invention includes: communication means for receiving event information from at least one of a plurality of sensor units; identification means for identifying, when the event information has been reported, at least one sensor unit different from the sensor unit from which the event information has been reported, from among the plurality of sensor units; and acquisition means for acquiring data related to the event from the sensor unit identified by the identification means.

A control method according to an exemplary aspect of the present invention includes: receiving event information from at least one of a plurality of sensor units; identifying, when the event information has been reported, at least one sensor unit different from the sensor unit from which the event information has been reported, from among the plurality of sensor units; and acquiring data related to the event from the sensor unit identified by the identification means.

A computer readable storage medium records thereon a program causing a computer to perform processes including: receiving event information from at least one of a plurality of sensor units; identifying, when the event information has been reported, at least one sensor unit different from the sensor unit from which the event information has been reported, from among the plurality of sensor units; and acquiring data related to the event from the sensor unit identified by the identification means.

A system according to an exemplary aspect of the present invention includes: a plurality of sensor units that are installed on pipes and detect a signal related to a physical amount; and a server communicable with each of the plurality of sensor units, wherein each of the sensor units includes: control means for detecting an event, based on the signal; and communication means for transmitting, when the event has been detected, event information indicating that the event has occurred, to the server, and the server includes: identification means for identifying, when the event information has been reported from at least one of the plurality of sensor units, at least one sensor unit different from the sensor unit from which the event information has been reported, from among the plurality of sensor units; communication means for acquiring the signal related to the event from the sensor unit identified by the identification means; and state detection means for detecting an abnormality of a pipe, based on the acquired signal related to the event.

### Advantageous Effects of Invention

The present invention allows a server side to acquire information for grasping a state of an object.

### BRIEF DESCRIPTION OF DRAWINGS

FIG. 1 is a block diagram illustrating functional blocks of a detection system of a first example embodiment.

FIG. 2 is a diagram illustrating a hardware configuration of the detection system of the first example embodiment.

FIG. 3 is a diagram illustrating a flow of an event detection method of a sensor unit of the first example embodiment.

FIG. 4 is a diagram illustrating how a server in the first example embodiment identifies a sensor unit.

FIG. 5 is a diagram illustrating how the server in the first example embodiment acquires a physical amount data.

FIG. 6 is a diagram illustrating how the server in the first example of embodiment transmits a physical amount data.

FIG. 7 is a diagram illustrating how a sensor unit in the second example embodiment detects an event.

FIG. 8 is a diagram illustrating how the server of the second example embodiment identifies a sensor unit for retrieving data.

FIG. 9 is a block diagram illustrating functional blocks of a detection system of a third example embodiment.

FIG. 10 is a diagram illustrating a specific example 1 of the third example embodiment.

FIG. 11 is a diagram illustrating a user interface of the specific example 1 of the third example embodiment.

FIG. 12 is a diagram illustrating a specific example 2 of the third example embodiment.

FIG. 13 is a diagram illustrating a user interface of the specific example 2 of the third example embodiment.

FIG. 14 is a diagram illustrating a user interface of a specific example 3 of the third example embodiment.

FIG. 15 is a diagram illustrating the specific example 2 of the third example embodiment.

FIG. 16 is a diagram illustrating a user interface of a specific example 4 of the third example embodiment.

FIG. 17 is a block diagram illustrating a characteristic configuration of the first example embodiment.

FIG. 18 is a block diagram illustrating another characteristic configuration of the first example embodiment.

FIG. 19 is a block diagram illustrating another characteristic configuration of the first example embodiment.

FIG. 20 is a block diagram illustrating a characteristic configuration of the third example embodiment.

### EXAMPLE EMBODIMENT

For addressing an issue in which a server could not acquire sufficient information amount to an extent to grasp a state of an object in detail, a solution such as reversible compression, irreversible compression, or feature extraction is conceivable to reduce data sent from sensor units. However, any of the solutions does not have a sufficient effect on an application of a sensor network in which a server executes calculation such as correlation calculation using measurement data at a plurality of positions in the sensor network at the same time. Specifically, in reversible compression, measurement data are reversibly compressed and transmitted. However, there is an issue that an information amount is generally reduced to only about 50%, and the data amount is still large. Therefore, there is room for improvement in the issue of the communication amount. In irreversible compression, measurement data are irreversibly compressed and transmitted, and information amount can be markedly reduced. However, an original waveform of a high-frequency component of the measurement data is lost, and therefore there is an issue that accuracy of calculation executed by a server may be impaired. In feature extraction, features included in measurement data are extracted and only the extracted features are transmitted to a server, and a data amount can be extremely reduced. However, it is difficult to restore the original measurement data from the features, and therefore there is an issue that it is impossible for the server to execute calculation by using measurement data. The above-described issues are also solved by the example embodiments of the present invention described below.

### First Example Embodiment

Hereinafter, example embodiments of the present invention will be described using the drawings. As a first example embodiment, a system that detects a state of an infrastructure facility by using sensors installed on the infrastructure facility will be described as an example. Note that the infrastructure facility may be a factory, a facility including pumps that extrude fluid, a facility including valves that control a flow rate of fluid, a bridge, a facility including water supply pipes, a facility including sewerage pipes, a facility including gas pipes, a piping network, a building, a house, a road, a facility including rails for a railroad vehicle, or the like. Further, the sensor may be a vibration sensor, a pressure sensor, a flow rate sensor, a water quality sensor, a temperature sensor, or the like.

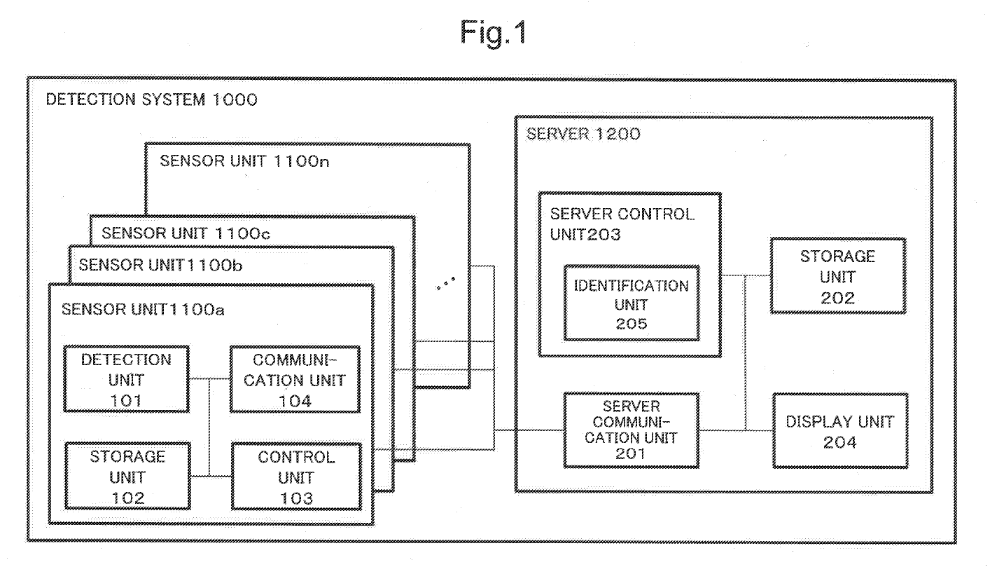

A configuration of the first example embodiment will be described using FIG. 1. FIG. 1 is a diagram illustrating a configuration of a detection system 1000 of the first example embodiment.

The detection system 1000 includes a plurality of sensor units 1100a to 1100n and a server 1200.

The sensor unit 1100 includes a detection unit 101, a storage unit 102, a control unit 103, and a communication unit 104. The sensor unit 1100 is installed on an infrastructure facility. The plurality of sensor units 1100a to 1100n may be installed on positions or infrastructure facilities different from one another. A distance between sensor units, with respect to the plurality of sensor units 1100a to 1100n, may be fixed. The sensor units 1100a to 1100n are time-synchronized with one another. The time synchronization of the sensor units 1100a to 1100n may be executed at a given cycle or executed based on an instruction from the server 1200. The sensor unit 1100 includes a time synchronization unit (not illustrated). A specific example of the time synchronization unit is a GPS synchronization oscillator that synchronizes a clock of an oscillator with a global positioning system (GPS) signal. The time synchronization unit receives the GPS signal and synchronizes the clock of the oscillator with the GPS signal, and thereby all the sensor units 1100 are synchronized with the GPS signal. Consequently, all the sensor units 1100 operate in synchronization with the same time.

Note that the time synchronization method is not limited to the above-described method, and a time synchronization method as disclosed in Japanese Patent Application Laid-Open Publication No. 2015-192388 is applicable.

The detection unit 101 detects a specific physical amount from an infrastructure facility. The detection unit 101 includes a signal reception unit (not illustrated) and a signal conversion unit (not illustrated). The signal reception unit receives data of a physical amount. The signal conversion unit converts (analog/digital (A/D)-converts) an analog signal of the physical amount data to a digital signal. The detection unit 101 stores an electric signal according to an amplitude and a frequency of a detected vibration on the storage unit 102 as a detection signal.

The storage unit 102 stores digitized physical amount data, signal processing data, various programs, a control period of a sensor, a control start timing of the sensor, a control termination timing of the sensor, and the like. The storage unit 102 stores physical amount data or signal processing data of the physical amount data for a given period (e.g. one day or one hour). The given period is not limited to one day or one hour. The storage unit 102 is a hard disk. The storage unit 102 may be a volatile memory or may be a non-volatile memory.

The control unit 103 controls the detection unit 101 and the communication unit 104. Specifically, the control unit 103 controls a control period or a control time, a control start timing, a control termination timing and the like of the detection unit 101. Further, the control unit 103 determines whether or not an event has occurred in the infrastructure facility, based on physical amount data. The event indicates a state where an abnormality, failure, or degradation of the infrastructure facility has occurred. The control unit 103 causes, in response to occurring of an event in the infrastructure facility, the communication unit 104 to transmit event information indicating that the event has occurred in the infrastructure facility, to the server 1200. The control unit 103 causes, in response to a request from the server 1200, the communication unit 104 to transmit physical amount data acquired in the detection unit 101, to the server 1200.

The communication unit 104 transmits, in response to determination by the control unit 103 that an event has occurred, event information to the server 1200 via a communication network. The communication unit 104 transmits, in response to a request from the server 1200, physical amount data stored in the storage unit 102 to the server 1200 via the communication network. The communication network is not specifically limited, and a publicly known communication channel network may be used as the communication network. Specifically, an Internet channel, a telephone channel, a local area network (LAN) and the like may be used as the communication channel, for example. The communication channel may be a wireless channel or a wired channel.

The server 1200 includes a server communication unit 201, a storage unit 202, a server control unit 203, and a display unit 204. The server 1200 is installed, for example, in an office of a management company of the infrastructure facility. Note that the server 1200 may be a portable device such as a mobile phone or a tablet.

The server communication unit 201 receives event information determined in each of the sensor units 1100a to 1100n via the communication network. The server communication unit 201 transmits a storage request for storing physical amount data of a predetermined period from a timing of detecting an event, to a plurality of sensor units 1100 identified in an identification unit 205 described later. The predetermined period may be ten minutes including five minutes before the event and five minutes after the event. Note that the predetermined period may be a time period such as ten minutes period or may be a time period between a start timing and a termination timing determined by a predetermined trigger. The server communication unit 201 transmits a physical amount data acquisition signal that is a request for transmitting physical amount data, to each of the sensor units 1100a to 1100n. The server communication unit 201 may be configured to transmit, with the request for transmitting, a time period or time for which the physical amount data is to be transmitted. The server communication unit 201 receives the physical amount data acquired in each of the sensor units 1100a to 1100n, via the communication network. Further, the server communication unit 201 may be configured to transmit a current time and the like to each of the sensor units 1100a to 1100n. The communication network is not specifically limited, and a publicly known communication channel network may be used. Specifically, an Internet channel, a telephone channel, a local area network (LAN) and the like may be used as the communication network, for example. These may be wireless channel or wired channel.

The storage unit 202 stores event information and physical amount data acquired by the server communication unit 201 from each of the sensor units 1100a to 1100n, various programs, and the like. The storage unit 202 is a hard disk drive. The storage unit 202 may be a volatile memory or may be a non-volatile memory.

The server control unit 203 includes an identification unit 205. The server control unit 203 stores acquired physical amount data on the storage unit 202. Further, the server control unit 203 determines a state of the infrastructure facility, based on the acquired physical amount data. Further, the server control unit 203 displays the determined state of the infrastructure facility via the display unit 204. The server control unit 203 may be configured to acquire the physical amount data directly from the server communication unit 201.

The display unit 204 may display symbols of the sensor units 1100 at positions of respective ones of the sensor units 1100 on a managed infrastructure facility by being overlapped with the infrastructure facility. The symbols may be a figure schematically indicating the sensor unit 1100 or may be a graphic such as a star, a circle, a triangle, a tetragon, a circular cylinder, a triangular pole, a circular cone, a triangular pyramid, or the like. Further, the display unit 204 may highlight a symbol of a sensor unit 1100 having transmitted event information. The highlighting may be achieved by changing a color, a pattern, a size or a shape or may be achieved by blinking. The display unit 204 may display a determination result of a degradation state of a pipe determined by the server control unit 203. The display unit 204 includes a liquid crystal display.

The identification unit 205 identifies a sensor unit 1100 having detected an event and a sensor unit 1100 related to the sensor unit 1100 having detected the event. A specific method for identifying the sensor units 1100 by the identification unit 205 will be described later. The identification unit 205 causes the server communication unit 201 to transmit a storage request for storing physical amount data of a predetermined period from a timing of detecting an event to the identified sensor units 1100.

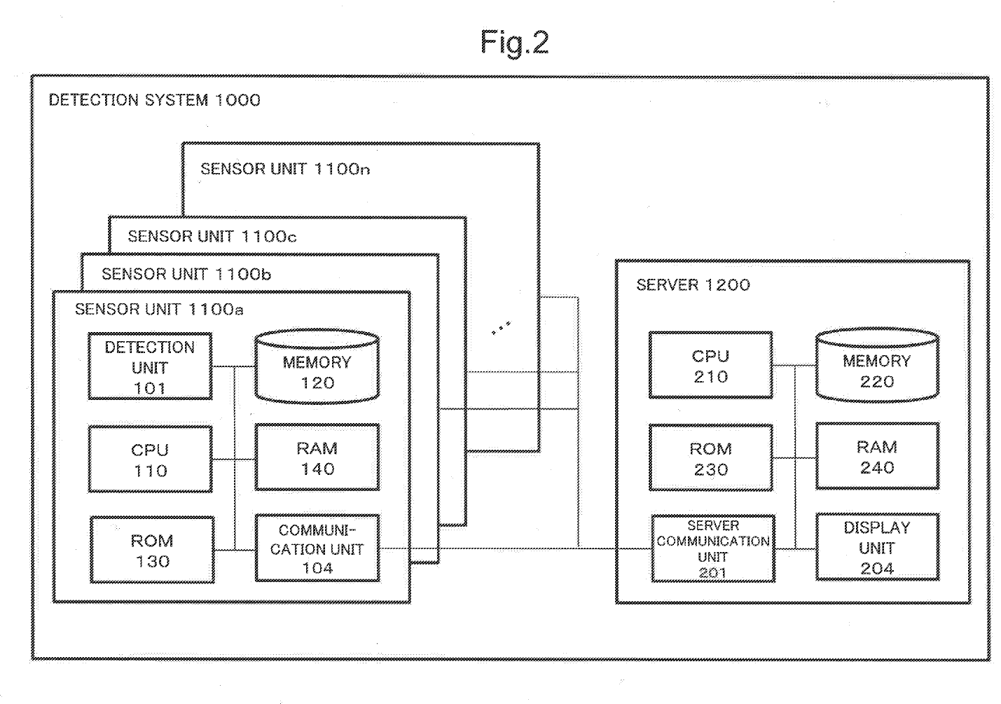

FIG. 2 is a block diagram illustrating a hardware configuration of the detection system 1000 of the first example embodiment.

The sensor unit 1100 includes a detection unit 101, a central processing unit (CPU) 110, a memory 120 that is a storage unit 102, a communication unit 104, a read only memory (ROM) 130, and a random access memory (RAM) 140. The CPU 110 is connected to the memory 120, the communication unit 104, the ROM 130, and the RAM 140. The CPU 110 may execute a program stored on the memory 120 as necessary, thus realizing the functional blocks illustrated in FIG. 1.

The server 1200 includes a central processing unit (CPU) 210, a memory 220 that is a storage unit 202, a server communication unit 201, a display unit 204, a read only memory (ROM) 230, and a random access memory (RAM) 240. The CPU 210 is connected to the memory 220, the server communication unit 201, the ROM 230, and the RAM 240. The CPU 210 may execute a program stored on the memory 220 as necessary, thus realizing the functional blocks illustrated in FIG. 1.

[Event Detection Method]

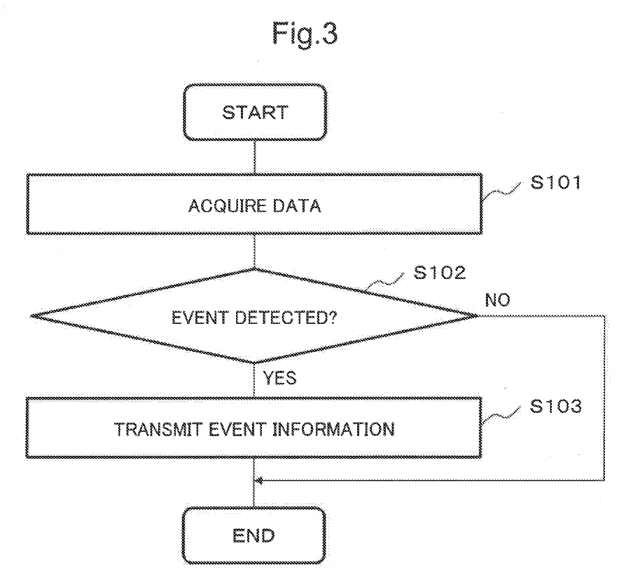

An event detection method of the sensor unit 1100 will be described using FIG. 3. FIG. 3 is a diagram illustrating a flow of detecting an event by the sensor unit 1100.

In step S101, the control unit 103 causes the detection unit 101 to collect physical amount data. The detection unit 101 A/D-converts the acquired physical amount data. The control unit 103 causes the detection unit 101 to store the A/D converted data on the storage unit 102 and moves to step S102.

In step S102, the control unit 103 determines whether or not an event has occurred, based on the acquired physical amount data. When the control unit 103 determines that an event has occurred, the control unit 103 generates event information and moves to step S103. When determining that an event has not occurred, the control unit 103 terminates the flow. A specific method for detecting an event in the control unit 103 is as follows. The control unit 103 determines that an event has occurred when a value of acquired physical amount data exceeds a predetermined value, and determines that an event has not occurred when the value of the acquired physical amount data is equal to or less than the predetermined value. Alternatively, as the method for detecting an event, the control unit 103 may be configured to detect an event when a change amount or a change rate of acquired physical amount data exceeds a predetermined value.

In step S103, the control unit 103 transmits the generated event information to the server 1200 via the communication unit 104 and terminates the flow. The control unit 103 may be configured to transmit the event information with event auxiliary information. The event auxiliary information is at least one of a maximum value, a minimum value, a change rate, a change amount, and inversion of a sign of acquired physical amount data. In other words, the event auxiliary information is information indicating a size of physical amount data or a magnitude of a change in physical amount data. The event auxiliary information is information for determining to what extent an event is likely to affect.

[Sensor Unit Identification Method]

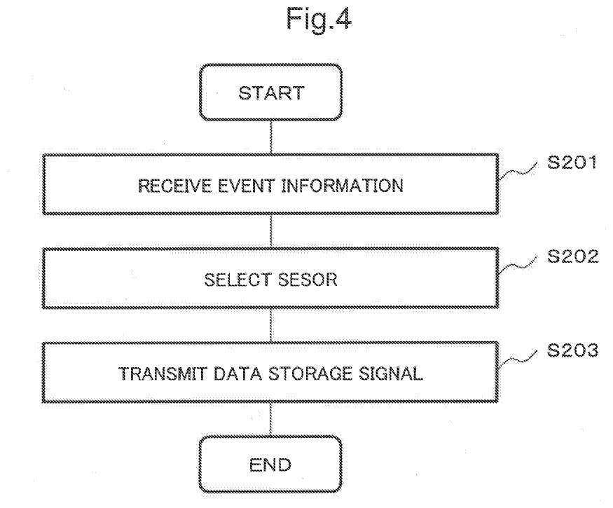

A sensor unit identification method of the server 1200 will be described using FIG. 4. FIG. 4 is a diagram illustrating a flow of a sensor unit identification method of the server 1200.

In step S201, the server communication unit 201 receives event information from each sensor unit 1100. The server control unit 203 stores the received event information on the storage unit 202 and moves to step S202.

In step S202, the server control unit 203 acquires event information stored on the storage unit 202. The server control unit 203 may be configured to acquire event information received in the server communication unit 201. The server control unit 203 identifies sensor units 1100 to be caused to store physical amount data, based on the acquired event information. The server control unit 203 stores information related to the identified sensor units 1100 on the storage unit 202 and moves to step S303.

As a method for identifying the sensor unit 1100, the server control unit 203 may execute any one of (1) to (6) described below or a combination of a plurality of (1) to (6).

(1) The server control unit 203 identifies each sensor unit 1100 from which event information has been received, as a sensor unit 1100 to be caused to store physical amount data.

(2) The server control unit 203 identifies a sensor unit 1100 from which event information has been received first and a sensor unit 1100 from which event information has been received in a predetermined time from a time of receiving the event information first, as a sensor unit 1100 to be caused to store physical amount data.

(3) The server control unit 203 identifies a sensor unit 1100 from which event information has been received first and a sensor unit 1100 adjacent to the sensor unit 1100 from which the event information has been received first, as a sensor unit 1100 to be caused to store physical amount data. The “adjacent sensor unit” may be defined as each sensor unit 1100 whose physical distance from the sensor unit 1100 from which the event information has been received falls within a predetermined range, a sensor unit 1100 in a group of previously determined sensor units to which the sensor unit 1100 from which the event information has been received belongs, a predetermined number (e.g. three) of sensor units 1100 selected in ascending order of physical distance from the sensor unit 1100 from which the event information has been received, a sensor unit 1100 installed on the same infrastructure facility as that on which the sensor unit 1100 from which the event information has been received is installed, or the like. Further, in the method for identifying the sensor unit 1100 by the server control unit 203, a sensor unit 1100 to be identified may be variable using event information and event auxiliary information.

(4) The server control unit 203 identifies each sensor unit 1100 from which event information has been received and a sensor unit 1100 adjacent to the sensor unit 1100 from which the event information has been received, as a sensor unit 1100 to be caused to store physical amount data.

(5) The server control unit 203 identifies a sensor unit 1100 from which event information has been received first, a sensor unit 1100 from which event information has been received in a predetermined time from a time of receiving the event information first, and a sensor unit 1100 adjacent to the sensor unit 1100 from which the event information has been received first or the sensor unit 1100 from which event information has been received in the predetermined time from the time of receiving the event information first, as a sensor unit 1100 to be caused to store physical amount data.

(6) The server control unit 203 identifies a sensor unit 1100 from which event information has been received first and each sensor unit 1100 existing in a predetermined range determined by auxiliary information, as a sensor unit 1100 to be caused to store physical amount data. When a maximum value or a minimum value of physical amount data is relatively large, an influence range of an event is wide, and therefore the server control unit 203 calculates a range wider than a previously determined range, as a predetermined range for identifying a sensor unit 1100. Similarly, when a change rate or a change amount of physical amount data is relatively large, an influence range of an event is wide, and therefore the server control unit 203 calculates a range wider than a previously determined range, as a predetermined range for identifying a sensor unit 1100. When auxiliary information includes an inversion of a sign of physical amount data, an influence range of an event is different, and therefore the server control unit 203 calculates a range by shifting a previously determined range by a predetermined distance, as a predetermined range for identifying a sensor unit 1100. Executing the method of (6) enables acquiring information from a more appropriate sensor unit 1100.

The server control unit 203 displays, on the display unit 204, symbols indicating the identified sensor units 1100 by being overlapped with a predetermined map, in such a way as to indicate positions on which respective ones of the sensor units 1100 are installed. The server control unit 203 may be configured to display, on the display unit 204, the identified sensor units 1100 and respective un-identified sensor units 1100 in different forms of symbols.

In step S203, the server control unit 203 causes the server communication unit 201 to transmit a data storage signal for storing physical amount data, to the identified sensor units 1100. The server communication unit 201 transmits the data storage signal to each of the identified sensor units 1100 and terminates the flow. The control unit 103 of each of the sensor units 1100 having received the data storage signal stores physical amount data to be stored on the storage unit 102, based on the data storage signal. The control unit 103 may be configured to delete physical amount data except the physical amount data to be stored, from the storage unit 102, based on the data storage signal.

[Physical Amount Data Acquisition Method]

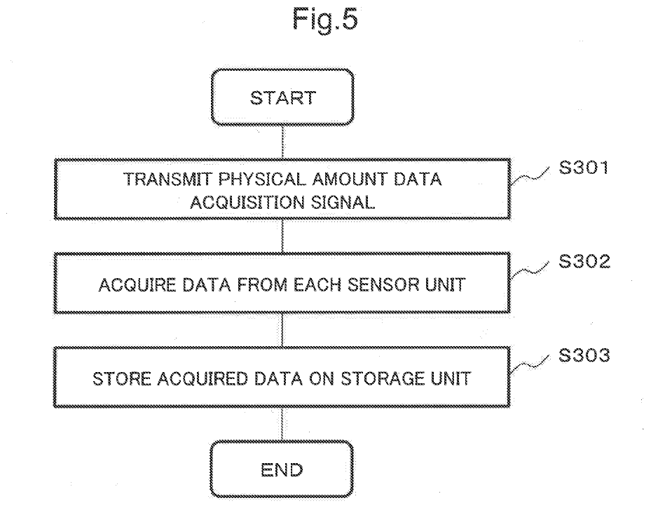

A physical amount data acquisition method of the server 1200 will be described using FIG. 5. FIG. 5 is a diagram illustrating a flow of a physical amount data acquisition method of the server 1200.

In step S301, at a physical amount data collection timing, the server control unit 203 causes the server communication unit 201 to transmit a physical amount data acquisition signal that is an instruction for transmitting physical amount data related to an event. The server communication unit 201 transmits the physical amount data acquisition signal to the respective identified sensor units 1100 and moves to step S302.

In step S302, the server communication unit 201 receives physical amount data related to the event from respective sensor units 1100 and moves to step S303.

In step S303, the server control unit 203 stores the received physical amount data on the storage unit 202 and terminates the flow.

[Physical Amount Data Transmission Method]

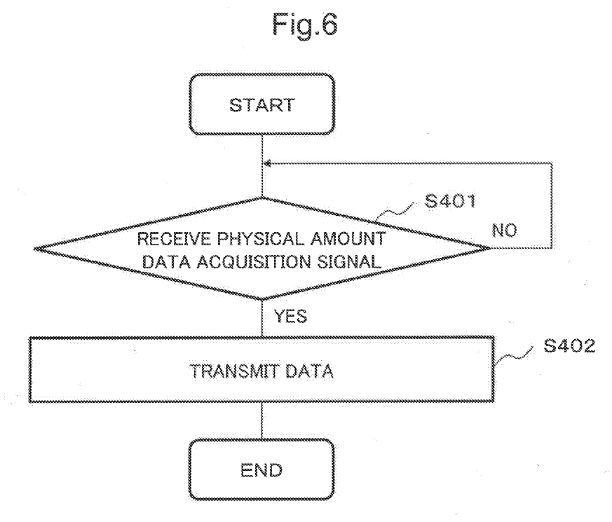

A physical amount data transmission method of the sensor unit 1100 will be described using FIG. 6. FIG. 6 is a diagram illustrating a flow of a physical amount data transmission method of the sensor unit 1100.

In step S401, the control unit 103 receives a physical amount data acquisition signal from the server communication unit 201 via the communication unit 104 and moves to step S402.

In step S402, the control unit 103 acquires physical amount data related to the event stored on the storage unit 102. The control unit 103 causes the communication unit 104 to transmit the acquired physical amount data of the event. The communication unit 104 transmits the acquired physical amount data of the event and terminates the flow.

[Characteristic Configurations]

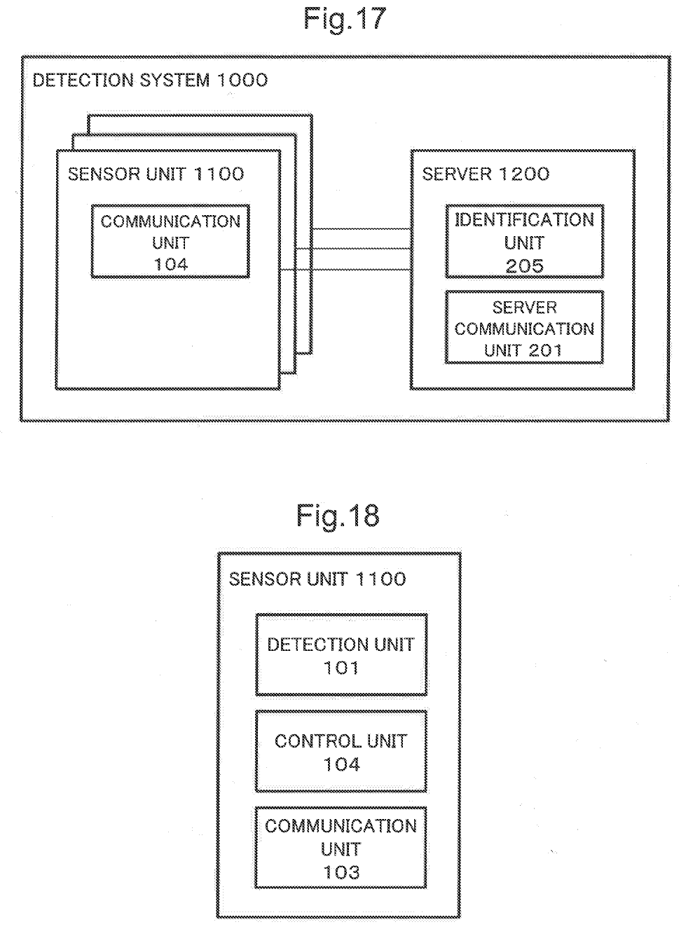

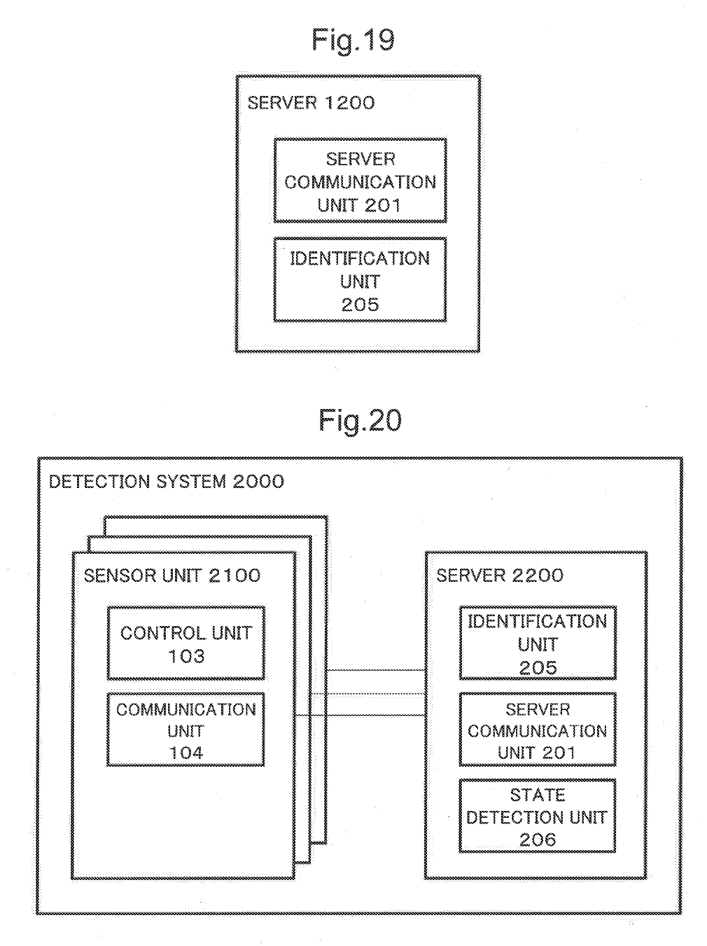

Characteristic configurations of the first example embodiment will be described. FIG. 17, FIG. 18, and FIG. 19 are block diagrams illustrating characteristic configurations of the first example embodiment.

Referring to FIG. 17, the detection system 1000 includes a plurality of sensor units 1100 and a server 1200 communicable with each of the plurality of sensor units 1100. The sensor unit 1100 includes a communication unit 104. The communication unit 104 transmits, when an event has been detected, event information indicating that the event has occurred to the server 1200. The server 1200 includes an identification unit 205 and a server communication unit 201. The identification unit 205 identifies, when the event information has been reported from at least one of the plurality of sensor units 1100, at least one sensor unit 1100 different from the sensor unit 1100 from which the event information has been reported, from among the plurality of sensor units 1100. The server communication unit 201 acquires data related to the event from the sensor unit 1100 identified by the identification unit 205.

Referring to FIG. 18, the sensor unit 1100 includes a detection unit 101, a communication unit 104, and a control unit 103. The detection unit 101 measures data related to a physical amount. The control unit 103 detects an event, based on the data. The communication unit 104 reports, when the event has been detected, event information indicating that the event has occurred to the server 1200. The control unit 103 further causes, when receiving a data transmission request from the server 1200, the communication unit 104 to transmit data related to the event to the server 1200.

Referring to FIG. 19, the server 1200 includes a server communication unit 201 and an identification unit 205. The server communication unit 201 receives event information from at least one of a plurality of sensor units 1100. The identification unit 205 identifies, when the event information has been reported, at least one sensor unit 1100 different from the sensor unit 1100 from which the event information has been reported, from among the plurality of sensor units 1100. The server communication unit 201 further acquires data related to the event from the sensor unit 1100 identified by the identification unit 205.

[Operational Advantage]

According to the first example embodiment, data related to an event is acquired from sensor units potentially related to the event, thus reducing a communication amount between each of the sensor units and a server. Further, there is no loss of data, thus reducing degradation in accuracy of state detection of an infrastructure facility.

### Second Example Embodiment

A configuration of functional blocks of a second example embodiment and a configuration of hardware are similar to the configurations of the first example embodiment, and therefore description will be omitted.

[Event Detection Method]

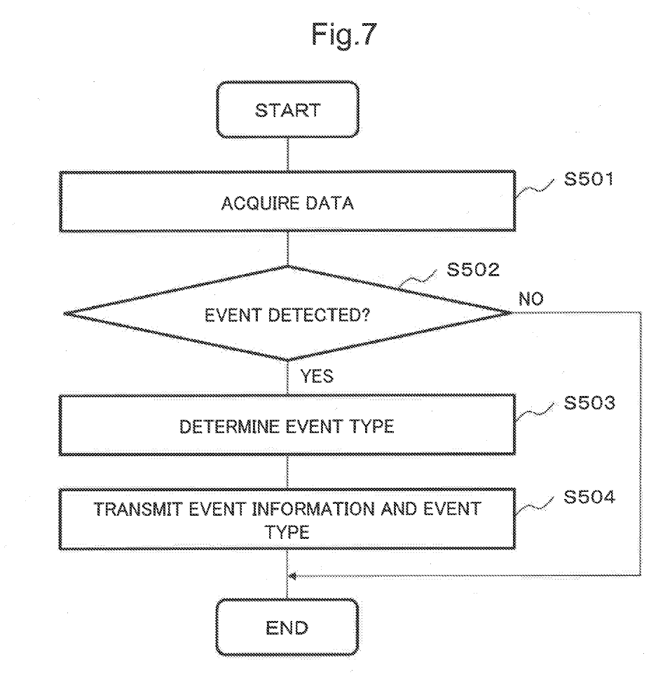

An event detection method of a sensor unit 1100 will be described using FIG. 7. FIG. 7 is a diagram illustrating a flow of detecting an event by the sensor unit 1100.

In step S501, the control unit 103 executes processing similar to the processing of step S101 of the first example embodiment, and moves to step S502.

In step S502, the control unit 103 executes processing similar to the processing of step S102 of the first example embodiment, and moves to step S503.

In step S503, the control unit 103 determines, when an event has been occurred, an event type based on acquired physical amount data and moves to step S504. The event type includes at least one of a state where a failure has been occurred in an infrastructure facility, a state where an abnormality has been occurred in the infrastructure facility, and a state where a degradation has been occurred in the infrastructure facility. In other words, the event type indicates a state of a pipe, and is intended to determine, even when events have occurred simultaneously and multiply, whether or not the events have occurred for a similar state. A specific method for determining an event type in the control unit 103 is as follows, for example. The control unit 103 determines the event type as a failure of an infrastructure facility when a time period, in which a maximum value of physical amount data is equal to or more than a predetermined value, is equal to or more than a predetermined period, determines the event type as a degradation of the infrastructure facility when a time period, in which a maximum value of physical amount data is equal to or more than a predetermined value, is less than a predetermined period, and determines the event type as an abnormality of the infrastructure facility when a time period, in which a maximum value of physical amount data is equal to or more than a predetermined period, is less than a predetermined period and such a time period has occurred intermittently.

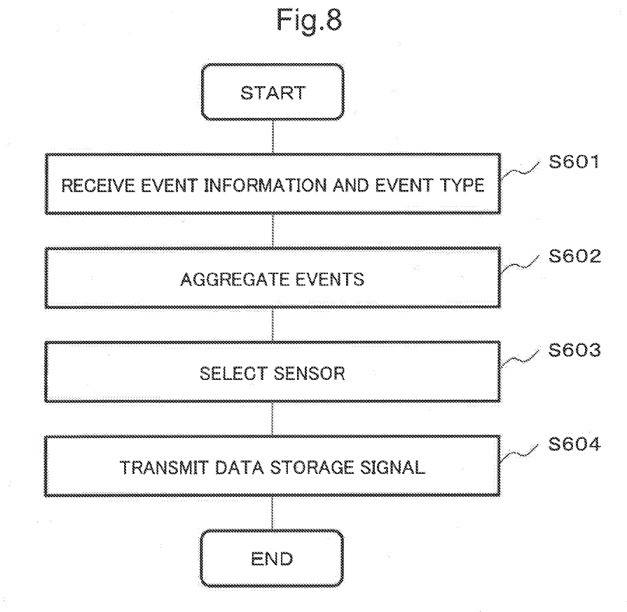

In step S504, the control unit 103 transmits the generated event information and event type to the server 1200 via the communication unit 104, and terminates the flow. The control unit 103 may be configured to transmit the event information with event auxiliary information.

[Sensor Unit Identification Method] A sensor unit identification method of the server 1200 will be described using FIG. 8. FIG. 8 is a diagram illustrating a flow of a sensor unit identification method of the server 1200.

In step S601, the server communication unit 201 receives event information and an event type from each sensor unit 1100. The server control unit 203 stores the received event information and event type on the storage unit 202 and moves to step S602.

In step S602, the server control unit 203 acquires an event type stored on the storage unit 202. The server control unit 203 aggregates, in response to receiving event information from the sensor unit 1100, pieces of event information, for each event type.

In step S603, the server control unit 203 acquires event information stored on the storage unit 202. The server control unit 203 may be configured to acquire event information received in the server communication unit 201. The server control unit 203 identifies sensor units 1100 to be caused to store physical amount data, based on the acquired event information. The server control unit 203 stores information related to the identified sensor units 1100 on the storage unit 202 and moves to step S604.

As a method for identifying the sensor unit 1100, the server control unit 203 may execute any one of (1) to (4) described below, a combination of (1) to (4), any one of (1) to (6) of the first example embodiment, or a combination of (1) to (4) of the present example embodiment and (1) to (6) of the first example embodiment.

(1) The server control unit 203 identifies, for each event type, each of the aggregated sensor units 1100, as a sensor unit 1100 to be caused to store physical amount data.

(2) The server control unit 203 identifies, for each event type, a sensor unit 1100 from which event information has been received first and a sensor unit 1100 adjacent to the sensor unit 1100 from which the event information has been received first, among the aggregated sensor units 1100, as a sensor unit 1100 to be caused to store physical amount data.

(3) The server control unit 203 identifies, for each event type, each of the aggregated sensor units 1100 and a sensor unit 1100 adjacent to each of the aggregated sensor units 1100, as a sensor unit 1100 to be caused to store physical amount data.

(4) The server control unit 203 identifies, for each event type, a sensor unit 1100 from which event information has been received first and each sensor unit 1100 existing in a predetermined range determined by auxiliary information, among the aggregated sensor units 1100, as a sensor unit 1100 to be caused to store physical amount data. The server control unit 203 may be configured to display, on the display unit 204, the aggregated sensor units 1100 with different form of symbol for each event type.

In step S604, the server control unit 203 causes the server communication unit 201 to transmit a data storage signal for storing physical amount data to the identified sensor units 1100. The server communication unit 201 transmits the data storage signal to each of the identified sensor units 1100 and terminates the flow. The control unit 103 of each of the sensor unit 1100 having received the data storage signal stores physical amount data to be stored on the storage unit 102, based on the data storage signal. The control unit 103 may be configured to delete physical amount data except the physical amount data to be stored, from the storage unit 102, based on the data storage signal.

[Physical Amount Data Acquisition Method]

A physical amount data acquisition method of the server 1200 is similar to the physical amount data acquisition method of the first example embodiment, and therefore description will be omitted.

[Physical Amount Data Transmission Method]

A physical amount data transmission method of the sensor unit 1100 is similar to the physical amount data transmission method of the first example embodiment, and therefore description will be omitted.

[Operational Advantage]

According to the second example embodiment, events are aggregated and sensor units are identified for each event on the server side, thus reducing a possibility that different events are misidentified as the same event, in addition to the advantageous effect of the first example embodiment.

### Third Example Embodiment

As a third example embodiment, a system that detects a pipe state of a water supply pipe by using vibration sensors installed on the water supply pipes will be described as an example. The “pipe state” in the present example embodiment indicates a state where a pipe is degraded and thinned, for example. The “pipe state” is not limited to the above state. The “pipe state” may be a state where an internal diameter of the pipe is narrowed due to deposits of materials on an internal wall of the pipe, a state where an external wall of the pipe is degraded due to corrosion, a state where the pipe is thickened due to adhesion of deposited materials on an external wall of the pipe, a state where these occur multiply, or the like.

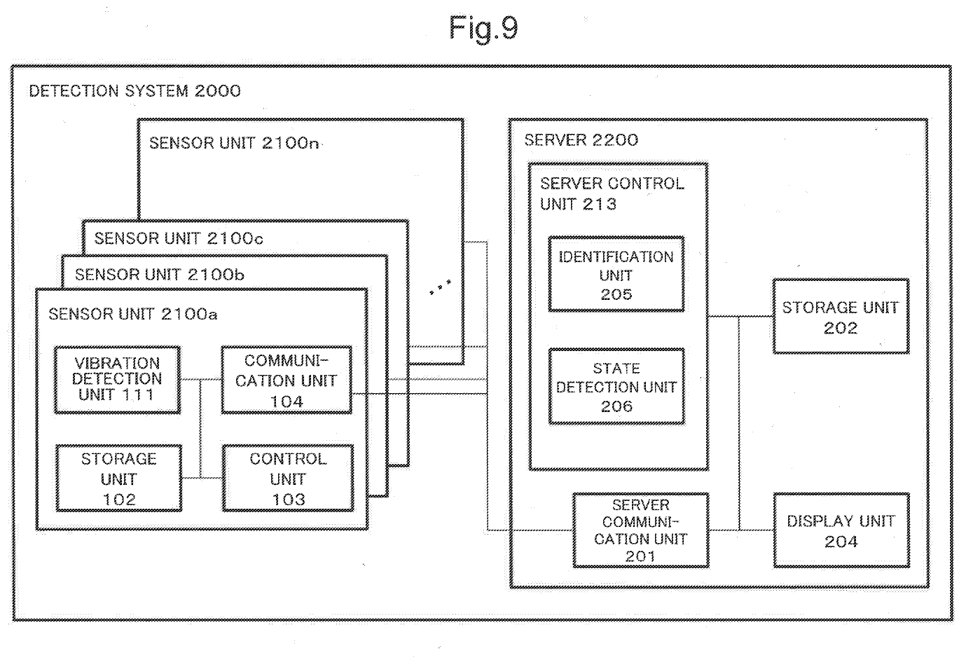

A configuration of the third example embodiment will be described using FIG. 9. FIG. 9 is a diagram illustrating a configuration of a detection system 2000 of the third example embodiment.

The detection system 2000 includes a plurality of sensor units 2100a to 2100n and a server 2200. The sensor unit 2100 may be a vibration sensor. Alternatively, the sensor unit 2100 may be a pressure sensor, an acceleration sensor, a water quality sensor, or a flow rate sensor. Further, the sensor unit 2100 may include a plurality of sensors. Specifically, the sensor unit 2100 may include at least two of a vibration sensor, a pressure sensor, an acceleration sensor, a water quality sensor, and a flow rate sensor.

The sensor unit 2100 includes a vibration detection unit 111, a storage unit 102, a control unit 103, and a communication unit 104. The sensor unit 2100 is installed on a sprinkler faucet of a pipe. Alternatively, the sensor unit 2100 may be installed on a wall face of an outside of a pipe, a wall face of an inside of the pipe, a water stop cock, a pressure damping valve, a pressure control valve, a tool connected to these, or the like. In the present example embodiment, it is assumed that there are a plurality of sensor units 2100. Alternatively, there may be one sensor unit 2100. A plurality of sensor units 2100a to 2100n may be installed on pipes different from one another. A distance between sensor units, with respect to the plurality of sensor units 2100a to 2100n, may be fixed. It is an advantage that, by installing sensor units 2100 directory on walls of pipes, vibrations are picked up easily. On the other hand, there is an issue that, when the pipes are buried under ground, installation of the sensor units 2100 is difficult. Installing the sensor units 2100 on sprinkler faucets or water stop valves is possible even when walls of pipes are not accessible directly, thus reducing an installation cost of the sensor units 2100.

The vibration detection unit 111 detects a vibration that propagates in pipes or fluid in the pipes. The vibration detection unit 111 includes a signal reception unit (not illustrated) and a signal conversion unit (not illustrated). The signal reception unit receives data of a vibration. The signal conversion unit converts (A/D-converts) an analog signal of the vibration data to a digital signal. The vibration detection unit 111 stores an electric signal according to an amplitude and a frequency of a detected vibration on the storage unit 102 as a detection signal.

The server 2200 includes a server communication unit 201, a storage unit 202, a server control unit 213, and a display unit 204. The server 2200 is installed, for example, in an office of a water supply company. Note that the server 2200 may be a portable device such as a mobile phone or a tablet.

The server control unit 213 includes an identification unit 205 and a state detection unit 206. The server control unit 213 stores acquired vibration data on the storage unit 202. Further, the server control unit 213 determines a state of the infrastructure facility, based on the acquired vibration data. Further, the server control unit 213 displays the determined state of the infrastructure facility via the display unit 204. The server control unit 213 may be configured to acquire the vibration data directly from the server communication unit 201.

The state detection unit 206 determines an abnormality, failure, or degradation of a pipe, based on the acquired vibration data. The determination can be achieved by an existing method. A specific method for detecting the abnormality of pipes may be a method as disclosed in Japanese patent application No. 2012-082165.

A hardware configuration of the detection system 2000 of the third example embodiment is similar to the hardware configuration of the first example embodiment, and therefore description will be omitted.

[Event Detection Method]

An event detection method of the sensor unit 2100 may be similar to the event detection method of the first example embodiment or the second example embodiment. The event detection methods of the first example embodiment and the second example embodiment are as described above, and therefore description will be omitted. Note that an event type in the present example embodiment includes a degradation of a pipe, water leakage from a pipe, or a water impact to a pipe. A specific method for determining an event type in the control unit 103 as follows, for example. The control unit 103 determines the event type as water leakage from a pipe when a time period, in which a maximum value of vibration data is equal to or more than a predetermined value, is equal to or more than a predetermined period, determines the event type as a water impact to a pipe when a time period, in which a maximum value of vibration data is equal to or more than a predetermined value, is less than a predetermined period, and determines the event type as a degradation of a pipe when a period, in which a maximum value of vibration data is equal to or more than a predetermined value, is less than a predetermined period and such a time period has occurred intermittently.

[Sensor Unit Identification Method]

A sensor unit identification method of the server 2200 may be similar to the sensor unit identification method of the first example embodiment or the second example embodiment. The sensor unit identification methods of the first example embodiment and the second example embodiment are as described above, and therefore description will be omitted. Note that the physical amount data in the first example embodiment and the second example embodiment corresponding to vibration data of the present example embodiment. Note that, as a method for identifying the sensor unit 2100 in the server control unit 213, in addition to the sensor unit identification methods of the first example embodiment and the second example embodiment, the following method may be used. As the method for identifying the sensor unit 2100, the server control unit 213 identifies each sensor unit 2100 from which event information has been received, and a sensor unit 2100 installed on the same pipe as that on which the sensor unit 2100 from which the event information has been received is installed, as sensor units 2100 to be caused to store vibration data. The storage unit 202 has previously stored sensor units 2100 installed on the same pipe.

[Vibration Data Acquisition Method]

A physical amount data acquisition method of the server 2200 is similar to the physical amount data acquisition method of the first example embodiment, and therefore description will be omitted.

[Physical Amount Data Transmission Method]

A physical amount data transmission method of the sensor unit 2100 is similar to the physical amount data transmission method of the first example embodiment, and therefore description will be omitted.

[Characteristic Configuration]

A characteristic configuration of the third example embodiment will be described. FIG. 20 is a block diagram illustrating a characteristic configuration of the third example embodiment.

Referring to FIG. 20, the detection system 2000 includes a plurality of sensor units 2100 that are installed on pipes and detect a signal related to a physical amount and a server 2200 communicable with the plurality of sensor units 2100. The sensor unit 2100 includes a control unit 103 and a communication unit 104. The control unit 103 detects an event, based on the signal. The communication unit 104 transmits, in response to detecting the event, event information indicating that the event has occurred to the server 2200. The server 2200 includes an identification unit 205, a server communication unit 201, and a state detection unit 206. The identification unit 205 identifies, in response to a report of event information from at least one of the sensor units 2100, at least one sensor unit 2100 different from the sensor unit 2100 from which the event information has been reported, from among the plurality of sensor units 2100. The server communication unit 201 acquires a signal related to the event from the sensor unit 2100 identified by the identification unit 205. The state detection unit 206 detects an abnormality of a pipe, based on the acquired signal related to the event.

[Operational Advantage] According to the third example embodiment, data related to an event is acquired from sensor units potentially related to the event, thus reducing a communication amount between a sensor unit and a server. Further, there is no loss of data, thus reducing degradation in accuracy of state detection of an infrastructure facility.

### Specific Example 1

A system that detects a pipe state of a water supply pipe by using vibration sensors installed on water supply pipes will be described using specific examples.

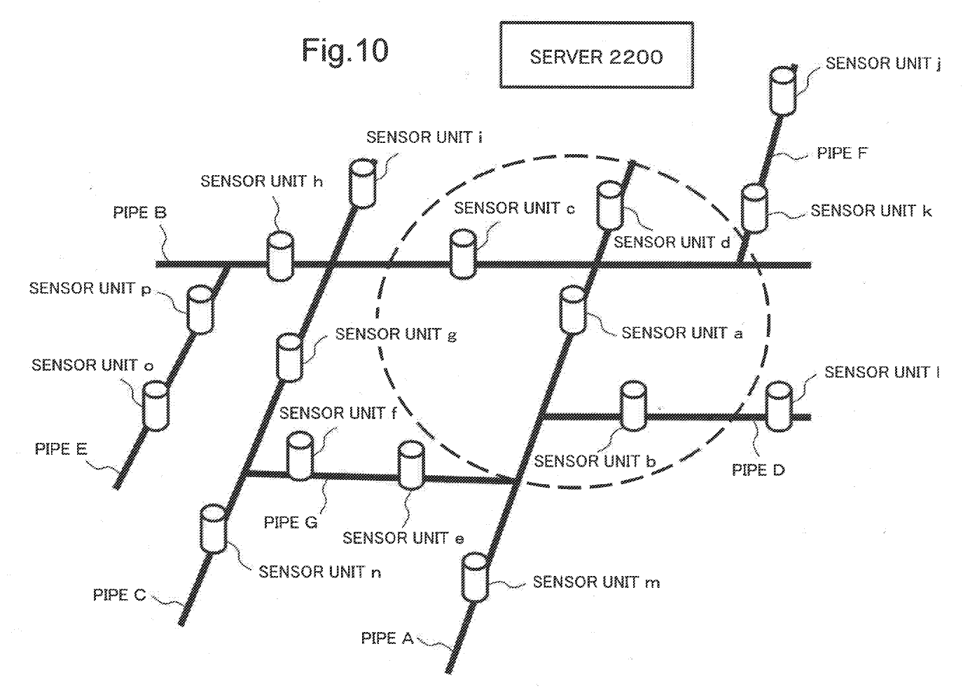

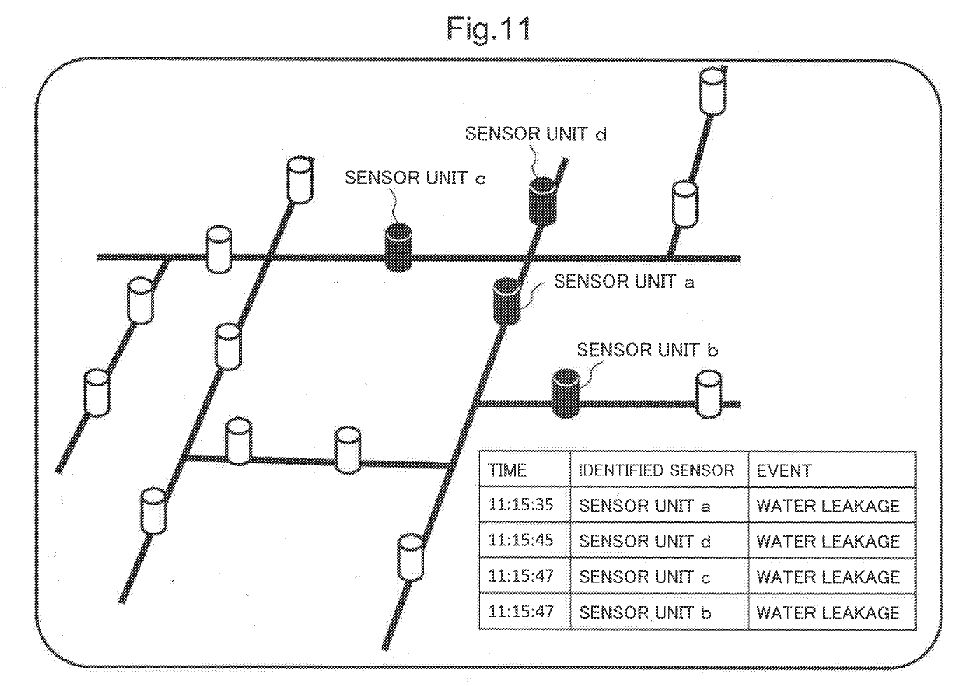

A specific example 1 will be described using FIGS. 10 to 11. FIG. 10 is a diagram in which a plurality of sensor units 2100 are installed on water supply pipes.

Pipes A to G are buried as water supply pipes. On the pipes A to G, sensor units a to p are installed. A case in which sensor units in a dotted line detect an event will be described. First of all, the sensor unit a detects an event first, and then the sensor unit d, the sensor unit c, and the sensor unit b detect the event in this order.

The sensor units a to d transmit, to the server 2200, event information, information indicating water leakage as an event type, and a time of detecting the event.

The server 2200 identifies the sensor units a to d as sensor units 2100 to be caused to store physical amount data. The server 2200 transmits a data storage signal for storing vibration data to the sensor units a to d. Further, the server 2200 transmits a physical amount data acquisition signal to the sensor units a to d.

The sensor units a to d transmit, in response to receiving the physical amount data acquisition signal, vibration data related to the water leakage to the server 2200.

Further, an example of a user interface displayed on the display unit 204 of the server 2200 will be described using FIG. 11. FIG. 11 is a diagram illustrating an example of a user interface displayed on the display unit 204 of the server 2200.

As illustrated in FIG. 11, the display unit 204 displays on a map a layout of pipes, symbols of sensor units a to p, sensor units in which an event has occurred, a time of detecting the event, and an event type. Further, the identified sensor units a to d are highlighted with a symbol different from that of other sensor units.

### Specific Example 2

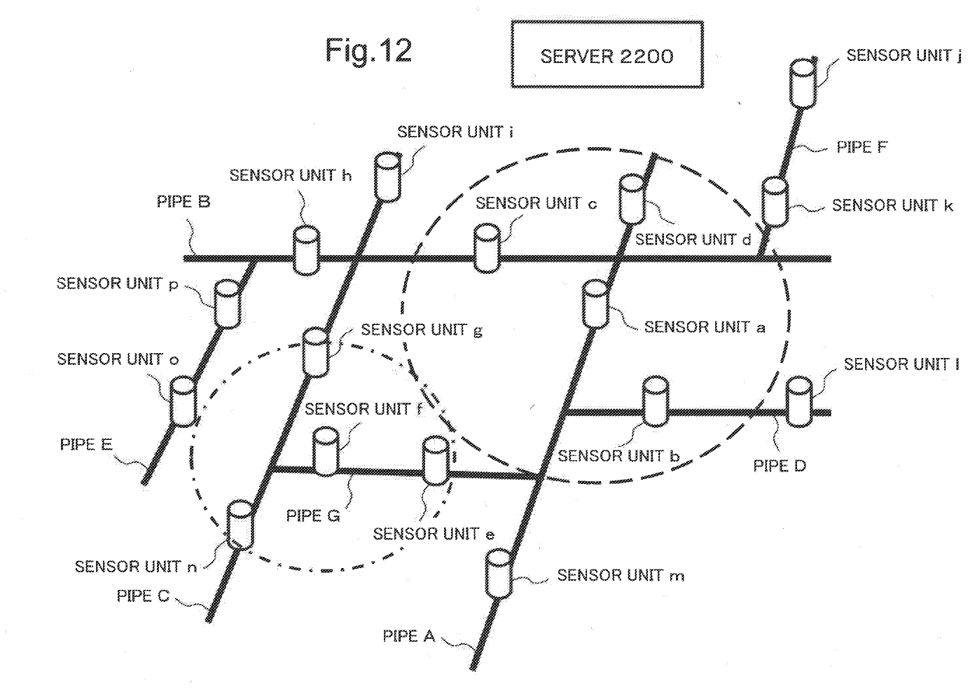

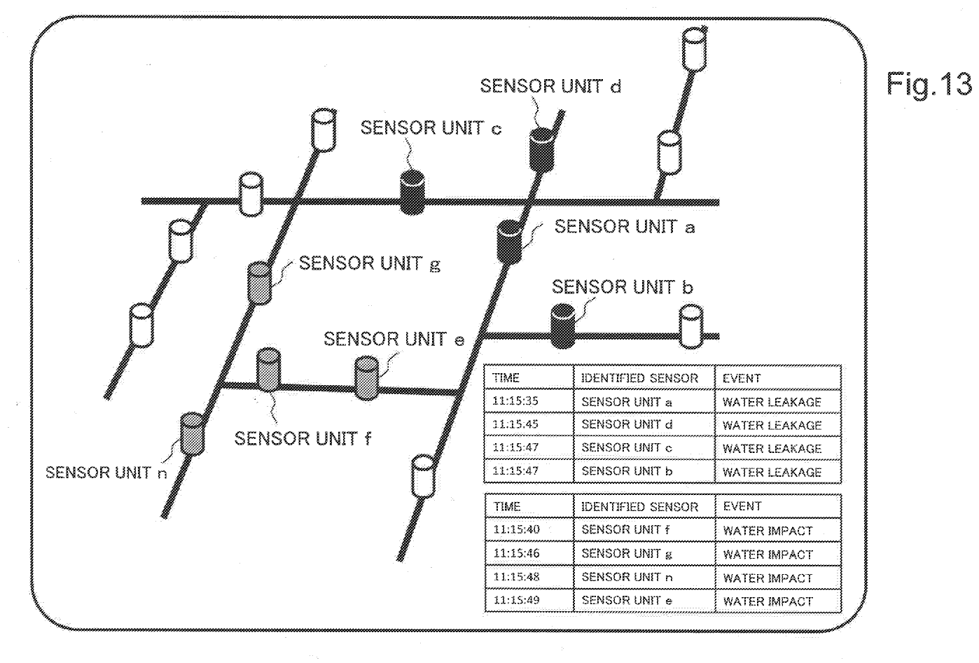

A specific example 2 will be described using FIGS. 12 to 13. FIG. 12 is a diagram in which a plurality of sensor units 2100 are installed on water supply pipes.

As water supply pipes, pipes A to G are buried. In the pipes A to G, sensor units a to p are installed. A case in which sensor units in a dotted line detect water leakage and sensor units in a dashed-dotted line detect a water impact will be described. First of all, with regard to the water leakage, the sensor unit a detects an event first, and then the sensor unit d, the sensor unit c, and the sensor unit b detect the event in this order. With regard to the water impact, the sensor unit f detects an event first, and then the sensor unit g, the sensor unit n, and the sensor unit e detect the event in this order.

The sensor units a to d transmit event information, information indicating the water leakage as an event type, and a time of detecting the event, to the server 2200. The sensor units e to g and n transmit event information, information indicating the water impact as an event type, and a time of detecting the event to the server 2200.

The server 2200 identifies the sensor units a to d as the first group according to the event type. Further, the server 2200 identifies the sensor units e to g and n as the second group. The server 2200 identifies the sensor units a to g and n as sensor units 2100 to be caused to store physical amount data. The server 2200 transmits a data storage signal for storing physical amount data to the sensor units a to d in the first group. Further, the server 2200 transmits a data storage signal for storing physical amount data to the sensor units e to g and n in the second group. The server 2200 transmits a physical amount data acquisition signal to the sensor units a to d. The server 2200 transmits a physical amount data acquisition signal to the sensor units e to g and n.

The sensor units a to g and n transmit, in response to receiving the physical amount data acquisition signal, vibration data related to the water leakage to the server 2200. The server 2200 executes water leakage detection, based on the vibration data from the sensor units a to d in the first group. Further, the server 2200 calculates damage to a pipe due to the water impact, based on the vibration data of the sensor units e to g and n in the second group, and determines a degradation of the pipe, based on the calculated damage.

Further, an example of a user interface displayed on the display unit 204 of the server 2200 will be described using FIG. 13. FIG. 13 is a diagram illustrating an example of a user interface displayed on the display unit 204 of the server 2200.

As illustrated in FIG. 13, the display unit 204 displays on a map a layout of pipes, symbols of sensor units a to p, sensor units in which an event has occurred, a time of detecting the event, and an event type. Further, the identified sensor units a to d are highlighted with a symbol different from that of other sensor units. In addition, the identified sensor units e to g and n are highlighted with a symbol different from that of the identified sensor units a to d. Such usage of the different highlights for sensor units in the first group and sensor units in the second group improves recognizability.

### Specific Example 3

A specific example 3 will be described using pressure sensors as the sensor units 2100. A system that detects burst of a water supply pipe by using the pressure sensors installed on water supply pipes will be described, in the specific example.

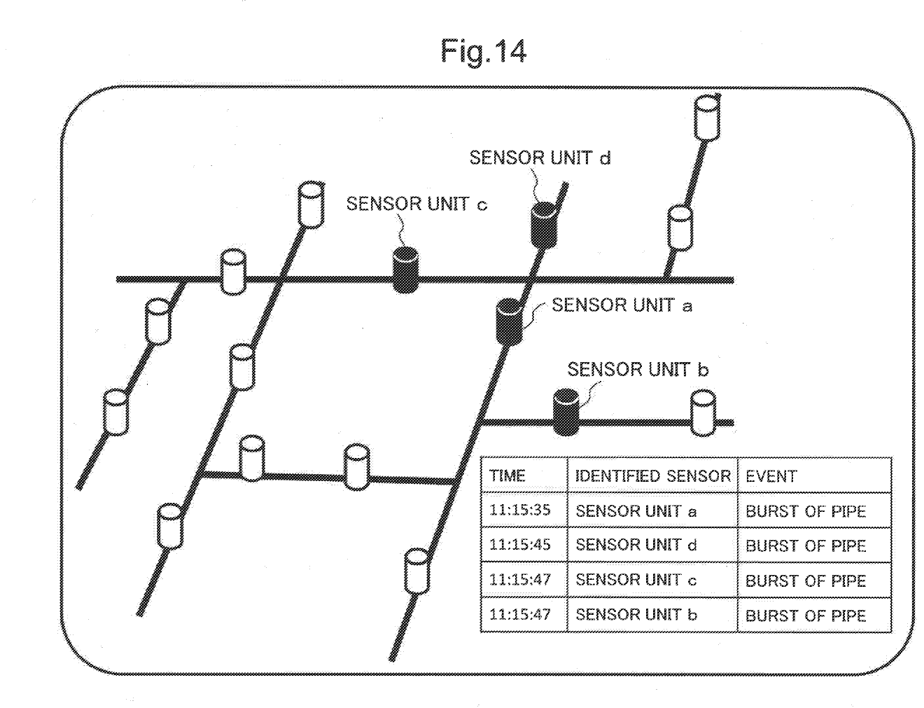

The specific example 3 will be described using FIGS. 10 and 14. FIG. 10 is a diagram in which a plurality of sensor units 2100 are installed on water supply pipes.

As the water supply pipes, pipes A to G are buried. On the pipes A to G, sensor units a to p are installed. A case in which sensor units in a dotted line detect an event will be described. First of all, the sensor unit a detects an event first, and then the sensor unit d, the sensor unit c, and the sensor unit b detect the event in this order.

The sensor units a to d transmit, to the server 2200, event information, information indicating the burst of a water supply pipe as an event type, and a time of detecting the event.

The server 2200 identifies the sensor units a to d as sensor units 2100 to be caused to store physical amount data. The server 2200 transmits a data storage signal for storing pressure data to the sensor units a to d. Further, the server 2200 transmits a physical amount data acquisition signal to the sensor units a to d.

The sensor units a to d transmit, in response to receiving the physical amount data acquisition signal, pressure data related to the burst of the water pipe to the server 2200.

Further, an example of a user interface displayed on the display unit 204 of the server 2200 will be described using FIG. 14. FIG. 14 is a diagram illustrating an example of a user interface displayed on the display unit 204 of the server 2200.

As illustrated in FIG. 14, the display unit 204 displays on a map a layout of pipes, symbols of sensor units a to p, sensor units in which an event has occurred, a time of detecting the event, and an event type.

Further, the identified sensor units a to d are highlighted with a symbol different from that of other sensor units. Note that the configuration of the specific example 3 is also applicable to the configuration of the specific example 2 with an appropriate modification.

### Specific Example 4

A specific example 4 will be described using, as the sensor units 2100, sensor units each including a vibration sensor and a pressure sensor. A system that diagnoses a pipe by a water impact, using the sensor units 2100 installed on water supply pipes, will be described, in the specific example.

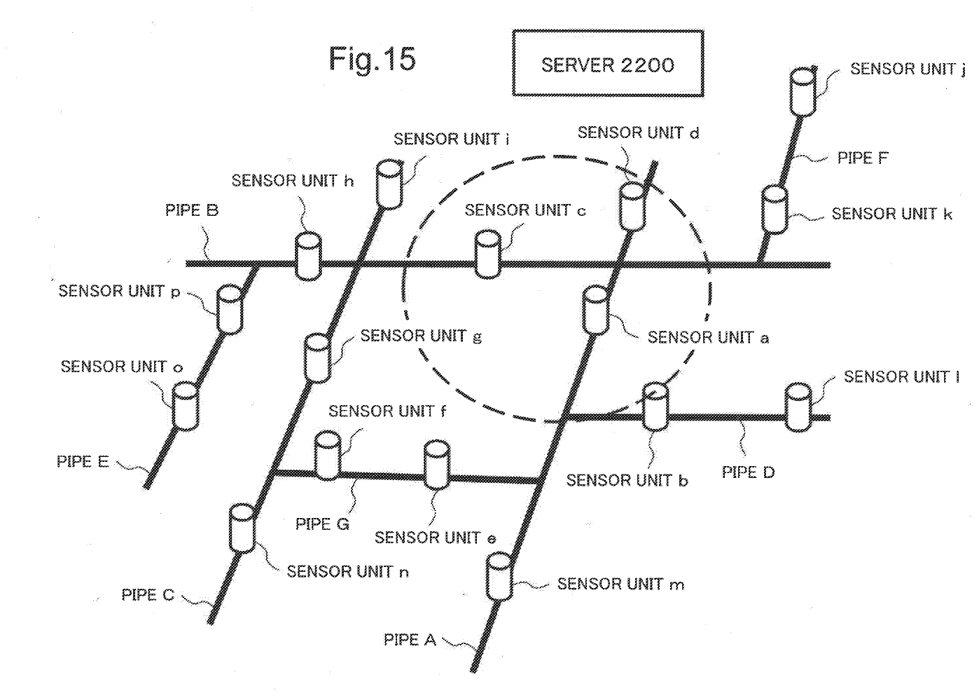

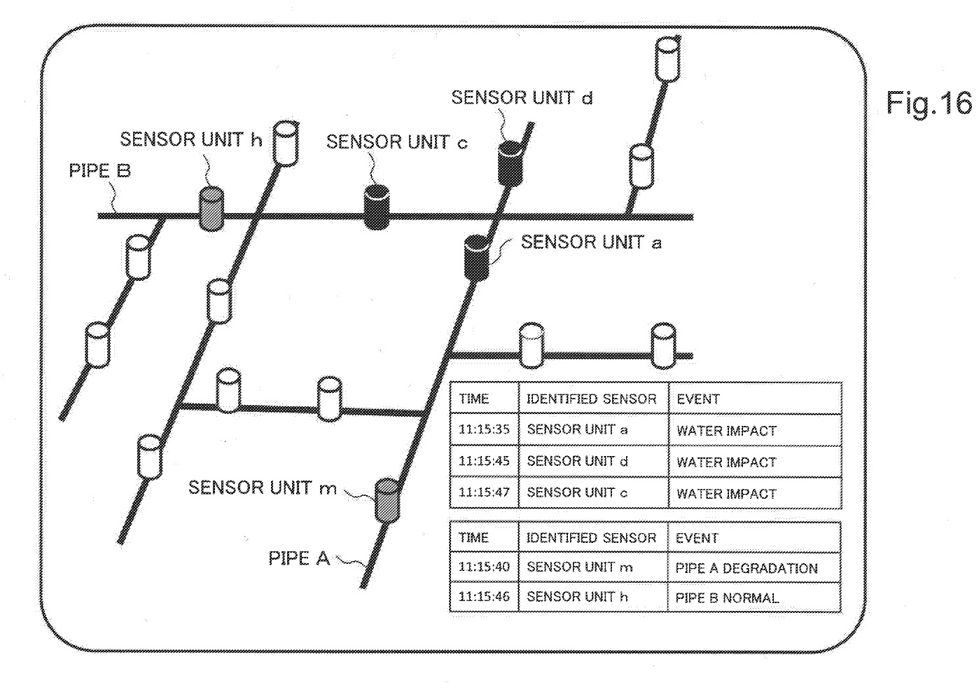

The specific example 4 will be described using FIGS. 15 and 16. FIG. 15 is a diagram in which a plurality of sensor units 2100 are installed on water supply pipes.

As the water supply pipes, pipes A to G are buried. On the pipes A to G, sensor units a to p are installed. A case in which sensor units in a dotted line detect an event will be described. First of all, the sensor unit a detects an event first, and then the sensor unit d and the sensor unit c detect the event in this order.

The sensor units a, c, and d transmit, to the server 2200, event information, information indicating the water impact as an event type, and a time of detecting the event.

The server 2200 identifies the sensor units a, c, and d as sensor units 2100 to be caused to store physical amount data. The server 2200 transmits a data storage signal for storing pressure data to the sensor units a, c, and d. Further, the server 2200 transmits a physical amount data acquisition signal to the sensor units a, c, and d.

The sensor units a, c, and d transmit, in response to receiving the physical amount data acquisition signal, pressure data related to the water impact to the server 2200.

The server 2200 identifies sensor units 2100 from which vibrations are to be acquired, based on the pressure data of the sensor units a, c, and d. Specifically, the server 2200 identifies sensor units that are installed on the same pipes and are not identified. In other words, the server 2200 identifies the sensor unit m installed on the pipe A on which the sensor unit a and the sensor unit d are installed, and the sensor unit h installed on the pipe B on which the sensor unit c is installed, as sensor units to be caused to store physical amount data. The server 2200 transmits a data storage signal for storing vibration data to the sensor units h and m. Further, the server 2200 transmits a physical amount data acquisition signal to the sensor units h and m.

The sensor units h and m transmit, in response to receiving the physical amount data acquisition signal, vibration data to the server 2200.

The server 2200 diagnoses a degradation of a pipe, based on the vibration data of the sensor units h and m.

Further, an example of a user interface displayed on the display unit 204 of the server 2200 will be described using FIG. 16. FIG. 16 is a diagram illustrating an example of a user interface displayed on the display unit 204 of the server 2200.

As illustrated in FIG. 16, the display unit 204 displays on a map a layout of pipes, symbols of the sensor units a, c, d, h, and m, sensor units in which an event has occurred, a time of detecting the event, and an event type. Further, the identified sensor units a, c and d are highlighted with a symbol different from that of other sensor units. In addition, the identified sensor units h and m are highlighted with a symbol different from that of the identified sensor units a, c, and d. Such usage of the different highlights improves recognizability. Note that, in the present specific example, a method for classification with respect to each group as in the specific example 2 is also applicable. The first example embodiment to the third example embodiment and the specific examples 1 to 3 of the third example embodiment described above may be appropriately combined, without departing from the technical idea of the present invention.

While the present invention has been particularly shown and described with reference to the example embodiments thereof, the present invention is not limited to the embodiments. It will be understood by those of ordinary skill in the art that various changes in form and details may be made therein without departing from the spirit and scope of the present invention as defined by the claims.

The whole or part of the example embodiments disclosed above can be described as, but not limited to, the following supplementary notes.

(Supplementary Note 1)

A system comprising:

a plurality of sensor units; and

a server communicable with each of the plurality of sensor units, wherein

each of the plurality of sensor units includes:
communication means for transmitting, when an event has been detected, event information indicating that the event has occurred, to the server, and

the server includes:
identification means for identifying, when the event information has been reported from at least one of the plurality of sensor units, at least one sensor unit different from the sensor unit from which the event information has been reported, from among the plurality of sensor units; and
server communication means for acquiring data related to the event from the sensor unit identified by the identification means.

(Supplementary Note 2)

The system according to supplementary note 1, wherein

the plurality of sensor units are installed on an infrastructure facility, and

the event is an event related to an abnormality, failure, or degradation of the infrastructure facility.

(Supplementary Note 3)

The system according to supplementary note 1 or 2, wherein

the event information is information indicating that the event has been occurred or information indicating a type of the event.

(Supplementary Note 4)

The system according to any one of supplementary notes 1 to 3, wherein

the event information includes information indicating a type of the event,

the identification means classify, when the event information has been reported from a plurality of sensor units, pieces of the event information into groups for respect types, and

the server communication means acquires, for each of the groups, data related to the event.

(Supplementary Note 5)

The system according to supplementary note 1, wherein

the server further includes server control means for classifying, when the event information has been reported from a plurality of sensor units, the sensor units from which the event information has been reported into one group.

(Supplementary Note 6)

The system according to any one of supplementary notes 1 to 5, wherein

the sensor unit further includes:
detection means for detecting a physical amount as a signal;
event detection means for detecting the event, based on the detected signal; and
storage means for storing the signal.

(Supplementary Note 7)

The system according to any one of supplementary notes 1 to 6, wherein

the server further includes:
display means for displaying symbols indicating the plurality of sensor units by being overlapped with a predetermined map in such a way as to indicate positions on which respective ones of the plurality of sensor units are installed; and
the display means displays the symbols in different forms depending on whether or not each of the plurality of sensor units is identified by the identification means.

(Supplementary Note 8)

The system according to any one of supplementary notes 1 to 7, wherein

the server communication means transmits event auxiliary information to the server, and

the identification means identifies, when the event information has been reported from at least one of the plurality of sensor units, at least one sensor unit different from the sensor unit from which the event information has been reported, from among the plurality of sensor units, based on the event auxiliary information.

(Supplementary Note 9)

The system according to supplementary note 8, wherein

the event auxiliary information is a maximum value of the data, a change rate of the data, or a change amount of the data.

(Supplementary Note 10)

A sensor unit comprising:

detection means for measuring data related to a physical amount;

control means for detecting an event, based on the data; and

communication means for reporting, when the event has been detected, event information indicating that the event has been occurred, to a server, wherein

the control means causes, when receiving a data transmission request from the server, the communication means to transmit the data related to the event to the server.

(Supplementary Note 11)

A server comprising:

communication means for receiving event information from at least one of a plurality of sensor units;

identification means for identifying, when the event information has been reported, at least one sensor unit different from the sensor unit from which the event information has been reported, from among the plurality of sensor units; and

acquisition means for acquiring data related to the event from the sensor unit identified by the identification means.

(Supplementary Note 12)

A control method comprising:

receiving event information from at least one of a plurality of sensor units;

identifying, when the event information has been reported, at least one sensor unit different from the sensor unit from which the event information has been reported, from among the plurality of sensor units; and

acquiring data related to the event from the identified sensor unit.

(Supplementary Note 13)

A computer readable storage medium recording thereon a program causing a computer to perform processes comprising:

receiving event information from at least one of a plurality of sensor units;

identifying, when the event information has been reported, at least one sensor unit different from the sensor unit from which the event information has been reported, from among the plurality of sensor units; and

acquiring data related to the event from the identified sensor unit.

(Supplementary Note 14)

A system comprising:

a plurality of sensor units that are installed on pipes and detect a signal related to a physical amount; and

a server communicable with each of the plurality of sensor units, wherein

each of the sensor units includes:
control means for detecting an event, based on the signal; and
communication means for transmitting, when the event has been detected, event information indicating that the event has occurred, to the server, and

the server includes:
identification means for identifying, when the event information has been reported from at least one of the plurality of sensor units, at least one sensor unit different from the sensor unit from which the event information has been reported, from among the plurality of sensor units;
communication means for acquiring the signal related to the event from the sensor unit identified by the identification means; and
state detection means for detecting an abnormality of a pipe, based on the acquired signal related to the event.

(Supplementary Note 15)

The system according to supplementary note 14, wherein

the event information is information indicating that the event has occurred, or a type of the event.

(Supplementary Note 16)

The system according to supplementary note 14 or 15, wherein

the identification means identifies, when the event information has been reported from at least one of the plurality of sensor unit, a sensor unit installed on the same pipe as the sensor unit from which the event information has been reported, from among the plurality of sensor units.

(Supplementary Note 17)

The system according to supplementary note 14 or 15, wherein

the communication means transmits, when the event has been detected, a maximum value of the signal to the server, and

the identification means identifies, when the event information has been reported from at least one of the plurality of sensor unit, at least one sensor unit different from a sensor unit from which the event information has been reported, from among the plurality of sensor units, based on the maximum value of the signal.

(Supplementary Note 18)

The system according to any one of supplementary notes 14 to 17, wherein

the sensor unit is a vibration sensor, a pressure sensor, an acceleration sensor, a water quality sensor, or a flow rate sensor.

(Supplementary Note 19)

The system according to supplementary note 15, wherein the event type is a degradation of the pipe, water leakage from the pipe, or a water impact to the pipe.

(Supplementary Note 20)

The system according to any one of supplementary notes 14 to 19, wherein

the server further includes:

display means for displaying symbols indicating the plurality of sensor units by being overlapped with a predetermined map in such a way as to indicate positions on which respective ones of the plurality of sensor units are installed, and

the display means displays the symbols in different forms depending on whether or not each of the plurality of sensor units is identified by the identification means.

(Supplementary Note 21)

The system according to supplementary note 20, wherein the display means displays the symbols in different forms, based on the event.

This application is based upon and claims the benefit of priority from Japanese patent application No. 2016-058797, filed on Mar. 23, 2016, the disclosure of which is incorporated herein in its entirety by reference.

### REFERENCE SIGNS LIST

101 Detection unit
111 Vibration detection unit
102, 202 Storage unit
103 Control unit
203, 213 Server control unit
104 Communication unit
201 Server communication unit
204 Display unit
205 Identification unit
206 State detection unit
110, 210 CPU
130, 230 ROM
140, 240 RAM
1000, 2000 Detection system
1100a to 1100n, 2100a to 2100n Sensor unit
1200, 2200 Server
120, 220 Memory

1. A system comprising:
a plurality of sensor units; and
a server communicable with each of the plurality of sensor units, wherein
each of the plurality of sensor units includes:
a memory storing instructions; and
one or more processors configured to execute the instructions to:
transmit, when an event has been detected, event information indicating that the event has occurred, to the server, and
the server includes:
a memory storing instructions; and
one or more processors configured to execute the instructions to:
identify, when the event information has been reported from at least one of the plurality of sensor units, at least one sensor unit different from the sensor unit from which the event information has been reported, from among the plurality of sensor units; and
acquire data related to the event from the identified sensor unit.

2. The system according to claim 1, wherein
the plurality of sensor units are installed on an infrastructure facility, and
the event is an event related to an abnormality, failure, or degradation of the infrastructure facility.

3. The system according to claim 1, wherein
the event information is information indicating that the event has been occurred or information indicating a type of the event.

4. The system according to claim 1, wherein
the event information includes information indicating a type of the event, and
the one or more processors in the server configured to further execute the instructions to:
classify, when the event information has been reported from a plurality of sensor units, pieces of the event information into groups for respect types, and
acquires, for each of the groups, data related to the event.

5. The system according to claim 1, wherein
the one or more processors in the server configured to further execute the instructions to:
classify, when the event information has been reported from a plurality of sensor units, the sensor units from which the event information has been reported into one group.

6. The system according to claim 1, wherein
the one or more processors in the sensor unit configured to further execute the instructions to:
detect a physical amount as a signal;
detect the event, based on the detected signal; and
store the signal.

7. The system according to claim 1, wherein
the one or more processors in the server configured to further execute the instructions to:
display symbols indicating the plurality of sensor units by being overlapped with a predetermined map in such a way as to indicate positions on which respective ones of the plurality of sensor units are installed; and
display the symbols in different forms depending on whether or not each of the plurality of sensor units is identified.

8. The system according to claim 1, wherein
the one or more processors in the server configured to further execute the instructions to:
transmit event auxiliary information to the server, and
identify, when the event information has been reported from at least one of the plurality of sensor units, at least one sensor unit different from the sensor unit from which the event information has been reported, from among the plurality of sensor units, based on the event auxiliary information.

9. The system according to claim 8, wherein
the event auxiliary information is a maximum value of the data, a change rate of the data, or a change amount of the data.

10. (canceled)

11. A server comprising:
a memory storing instructions; and
one or more processors configured to execute the instructions to:
receive event information from at least one of a plurality of sensor units;
identify, when the event information has been reported, at least one sensor unit different from the sensor unit from which the event information has been reported, from among the plurality of sensor units; and
acquire data related to the event from the identified sensor unit.

12. A control method comprising:
receiving event information from at least one of a plurality of sensor units;
identifying, when the event information has been reported, at least one sensor unit different from the sensor unit from which the event information has been reported, from among the plurality of sensor units; and
acquiring data related to the event from the identified sensor unit.

13-21. (canceled)
